(19) United States
(12) Patent Application Publication
(10) Pub. No.: US 2007/0210108 A1
(43) Pub. Date: Sep. 13, 2007

(54) Transparent grease gun

(76) Inventors: Michael D. Cline, Moreno Valley, CA (US); Fernando J. Sumaya, Yorbalinda, CA (US)

Correspondence Address: ROBERT M. SPERRY, ESQ., 23390 OSTRONIC DRIVE, WOODLAND HILLS, CA, 91367, US

(21) Appl. No.: 11/205,744

(22) Filed: Aug. 17, 2005

(51) Int. Cl. B67D 5/38

(52) U.S. Cl. 222/154; 222/256

(57) ABSTRACT

An improved grease gun having a cylinder formed of transparent polycarbonate material to permit visual inspection of the type and quantity of grease contained therein and which is strong and durable and which has memory, so that even when subjected to major deformation, the cylinder will resume its original shape after the deformation has ceased.

### RELATED CASES

This invention is described in my copending provisional application, Ser. No. 60/589,069, filed Jul. 20, 2004, and now ______.

### FIELD OF INVENTION

This invention relates to grease guns and is particularly directed to improved grease guns having transparent cylinders.

### PRIOR ART

Grease guns have long been used for lubricating vehicles, machinery and the like and have been far more efficient, neat, clean and accurate than previous greasing methods. Grease guns carry a supply of grease in a cylinder and use manual or motorized means to deliver the grease from the cylinder to suitable fittings on the machinery to be lubricated. Modern grease guns can be supplied by manually filling the cylinder or by connecting a grease source, such as a barrel, through a pressure supply system to supply the grease to the cylinder. Grease guns are used in proximity to heavy equipment and, hence, the cylinders have previously been formed of metal which was strong enough to withstand rough treatment. However, these metal cylinders have been opaque, which makes it difficult, if not impossible, to tell how much grease remains in the cylinder. Consequently, it is not uncommon for someone to pump air into the grease fitting instead of grease. This leaves the equipment partially or completely unlubricated, which can cause damage or destruction to the machine. Furthermore, with the opaque cylinders, it is not possible to see what type of grease is in the cylinder. It is customary to provide some sort of grease identifying means, such as a tag. However, it is not uncommon for the tags to be misapplied, causing the user to apply the wrong grease, which can result in serious damage to the machine. In the U.S. military services, the standard operating procedure calls for a user to “sniff” the cylinder to determine the type of grease contained therein. Obviously, such a “sniff” test is extremely unreliable. Also, if the metal cylinders are crushed, as by being run over by a truck, the metal cylinders are destroyed. It has been proposed to make grease gun cylinders of nylon. However, nylon is opaque, absorbs moisture and contracts when going from wet to dry conditions. It has also been proposed to make grease gun cylinders of acrylonitrile styrene. However, this material is brittle and has low strength. Again, it has been proposed to make grease gun cylinders of polypropelene, which is generally not clear and, when made clear, is flexible and weak. Thus, none of the prior art grease guns have been entirely satisfactory.

### BRIEF SUMMARY AND OBJECTS OF INVENTION

These disadvantages of the prior art are overcome with the present invention and improved grease guns are provided having transparent cylinders which enable the user to readily see the quantity of grease remaining in the cylinder and to be able to quickly, easily and positively see the type of grease contained in the grease gun cylinder, thereby ensuring that no air will be delivered to the machinery and that only the proper type of grease will be supplied. Also, the grease gun cylinders of the present invention are strong and rugged and can withstand severe treatment, such as being run over by trucks, without damage to the grease gun cylinder.

These advantages of the present invention are preferably attained by providing an improved grease gun having a cylinder formed of transparent polycarbonate material to permit visual inspection of the type and quantity of grease contained therein and which is strong and durable and which has memory, so that even when subjected to major deformation, the cylinder will resume its original shape after the deformation has ceased.

Accordingly, it is an object of the present invention to provide an improved grease gun.

Another object of the present invention is to provide an improved grease gun having a transparent cylinder.

An additional object of the present invention is to provide an improved grease gun having a cylinder which is transparent and which has memory so that it will resume its original shape, even after major deformation.

A further object of the present invention is to provide an improved grease gun having a transparent cylinder which enables the user to quickly and easily see the quantity of grease remaining in the grease gun.

Another object of the present invention is to provide an improved grease gun having a transparent cylinder which enables the user to quickly, easily and accurately see the type of grease contained in the grease gun.

A specific object of the present invention is to provide an improved grease gun having a cylinder formed of transparent polycarbonate material to permit visual inspection of the type and quantity of grease contained therein and which is strong and durable and which has memory, so that even when subjected to major deformation, the cylinder will resume its original shape after the deformation has ceased.

These and other objects and features of the present invention will be apparent from the following detailed description, taken with reference to the figures of the accompanying drawing.

### BRIEF DESCRIPTION OF THE DRAWING

FIG. 1 is a side view of a grease gun embodying the present invention;

FIG. 2 is a side view of the cylinder of the grease gun of FIG. 1; and

FIG. 3 is an end view of the cylinder of FIG. 2.

### DETAILED DESCRIPTION OF THE INVENTION

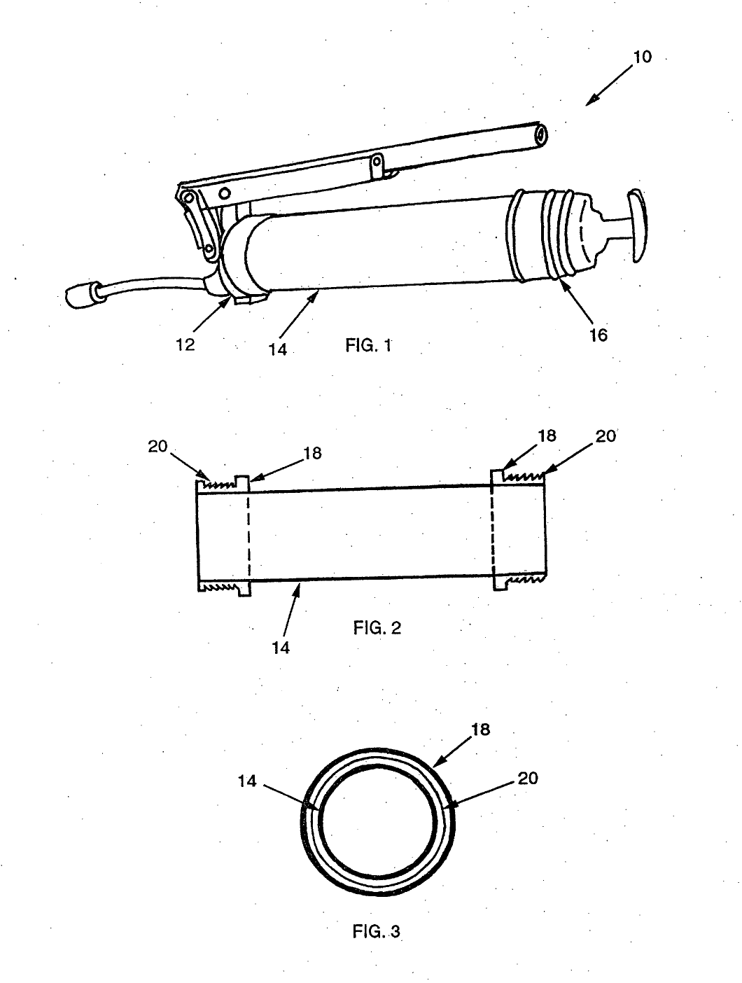

In that form of the present invention chosen for purposes of illustration, FIG. 1 shows a grease gun, indicated generally at 10, having a pump head 12, a cylinder 14 and a pressure cap 16. The pump head 12 and pressure cap 14 are screwed onto the end caps 18 of the cylinder 14. As is well known, numerous different types of pump head 12 and pressure cap 14 are commonly in use and any of these may be substituted for those shown simply by unscrewing the cylinder 14 from the undesired components and replacing these with the desired ones. The cylinder 14 is formed of strong, transparent material, such as polycarbonate. This material is transparent and is extremely strong. Cylinders made of polycarbonate have been run over by trucks without damage. Also, the polycarbonate material has a memory. Thus, in pressure tests where the cylinder 14 was subjected to extreme pressure sufficient to reduce the length of the cylinder 14 by approximately one inch, the cylinder 14 immediately sprang back to its original length when the pressure was removed. The end caps 18 are formed of suitable metal, such as T 6061 Aircraft Aluminum, and are threaded, as seen at 20, to mate with corresponding threads on the pump head 12 and pressure cap 16.

In use, the cylinder 14 is screwed into assembly with a desired pump head 12 and pressure cap 16 and the grease gun 10 is ready for use. The cylinder 14 can be filled in the usual manner with any desired type of grease and the user can immediately see the amount and type of grease contained in the cylinder 14 by simply viewing it. This eliminated the need for engraving the type of grease on the cylinder, applying identification tags or other conventional identification means, yet provides immediate and positive identification of the amount and type of grease contained in the cylinder 14 by simple visual inspection, which is faster and more positive that any of the prior art identification techniques.

Obviously, numerous variations and modifications can be made without departing from the spirit of the present invention. Therefore, it should be clearly understood that the form of the present invention described above and shown in the figures of the accompanying drawing is illustrative only and is not intended to limit the scope of the present invention.

What is claimed is:

1. A grease gun comprising:
a cylinder having means enabling a user to visually determine the type and quantity of grease contained therein.

2. The grease gun of claim 1 wherein:
said cylinder is transparent.

3. The grease gun of claim 1 wherein:
said cylinder is made of polycarbonate.

4. The grease gun of claim 1 wherein:
a pump head, and
a pressure cap,
said cylinder being interposed between said pump head and said pressure cap.

5. The grease gun of claim 4 wherein:
said pump head and said pressure cap are threadedly secured to said cylinder.

6. A grease gun cylinder which enables visual determination of the type and quantity of grease contained therein.

7. The cylinder of claim 6 wherein:
said cylinder is transparent.

8. The cylinder of claim 6 wherein:
said cylinder is formed of plastic.

9. The cylinder of claim 6 wherein:
said cylinder is made of polycarbonate.

10. The cylinder of claim 6 further comprising:
end caps mounted on each end of said cylinder and threaded to permit threaded assembly with other components of a grease gun.

11. The cylinder of claim 10 wherein:
said end caps are made of metal.

12. The cylinder of claim 10 wherein:
said end caps are made of T 6061 Aircraft aluminum.
